(19) United States
(12) Patent Application Publication
(10) Pub. No.: US 2009/0076895 A1
(43) Pub. Date: Mar. 19, 2009

(54) SHOPPING CART ACCOUNTABILITY USING COUPON INCENTIVES

(76) Inventors: John R. French, San Diego, CA (US); James M. Irish, San Diego, CA (US)

Correspondence Address: NYDEGGER & ASSOCIATES, 348 OLIVE STREET, SAN DIEGO, CA, 92103, US

(21) Appl. No.: 11/855,026

(22) Filed: Sep. 13, 2007

(51) Int. Cl. G06Q 30/00

(52) U.S. Cl. 705/14

(57) ABSTRACT

A system and method encourage a shopper to return a shopping cart to a corral at a store. In the system, detectors recognize the shopper and the cart selected by the shopper at the cart corral. Further, the system includes a scanner at the point-of-sale that recognizes the shopper and records the goods purchased by the shopper. During operation of the system, a controller monitors the goods purchased by the shopper and determines suggested goods for subsequent purchase by the shopper. If the shopper returns the cart to the cart corral, the controller provides the shopper with coupons for the suggested goods. In order to provide the shopper with the coupons for purchase of the suggested goods, the system may include a coupon dispenser mounted on the cart or on the cart corral.

### FIELD OF THE INVENTION

The present invention pertains generally to systems and methods for reducing theft of shopping carts and for reducing labor involved in collecting shopping carts. More particularly, the present invention pertains to systems that encourage the return of shopping carts to corrals by shoppers. The present invention is particularly, but not exclusively, useful as a system that identifies a shopper, the cart used by the shopper, and the goods purchased by the shopper during a shopping visit in order to provide incentive coupons to the shopper if the shopper returns the cart to the corral.

### BACKGROUND OF THE INVENTION

At supermarkets, shopping carts are conventionally provided for the convenience of shoppers to allow large amounts of goods to be collected, paid for and unloaded at the shoppers' cars. While some shoppers voluntarily return carts to a cart return location, such as a cart corral, often shoppers leave the carts in the vicinity of where their vehicles are parked. As a result, the empty carts must be collected by store personnel and returned to the store for subsequent use. While this may appear to be a minor matter, substantial labor costs may be incurred in order to continually retrieve the carts from the parking complex. For instance, a typical store may spend from one to six man-years in the collection process, and incur additional indirect costs associated with injury and disability claims. Worldwide, labor costs associated with cart collection add up to millions of dollars.

When carts are not collected quickly enough, parking spots may be littered with carts that will discourage other shoppers from parking at the store. Further, damages may be incurred when shoppers strike carts with their cars. While stores can disclaim liability for damage to the cars, legal costs can still be significant in defending against baseless suits. Further, the carts themselves may be damaged.

In other cases, some carts may be removed from the store parking lot. For example, shoppers without vehicles may use the carts to transport goods back to their homes and then abandon the carts. As a result, the store may permanently lose these carts, resulting in substantial financial loss to the store owner, since each cart is a relatively expensive piece of equipment. Because it is common for shoppers to “borrow” carts to transport their purchases home or to a transit stop, store owners must contract for regular cart retrieval services. These retrieval contractors comb their neighborhoods several times per day or week, at a cost of thousands of dollars per site per year. Once off-site, carts are often taken great distances, experiencing worn wheels and other damage. Further, rough handling during the collection process often damages the retrieved carts. In addition, extra cleaning and repair may be required following retrieval. This can add thousands of dollars of additional expenses per store per year. Also, to compensate for carts that are off-site, store owners typically must maintain excess cart inventories, often 10% to 20% over their actual need, to ensure that enough carts are available during peak shopping hours. At some sites, the total of all these costs may exceed $100,000 per site.

In light of the above, it is an object of the present invention to provide a system and method for encouraging the return of shopping carts to a corral. Another object of the present invention is to provide a system and method that delivers targeted coupons to a shopper during a shopping visit, if the shopper returned his cart to a corral after a previous shopping visit. Still another object of the present invention is to provide a system and method that monitors and records a shopper's purchasing history and cart return history in order to encourage the shopper to return his cart. Yet another object of the present invention is to provide a cart return incentive that reinforces store loyalty and creates a new means for advertisers to deliver specific incentives to specific shoppers, based on shopper history. It is another object of the present invention to provide a cart return incentive system and method that is easy to implement, cost effective and simple to use.

### SUMMARY OF THE INVENTION

In accordance with the present invention, a system is provided for encouraging a shopper to return a shopping cart to a corral at a store. The system includes a token detector for recognizing the shopper. Specifically, the token detector reads a token, such as a frequent shopper card, that is carried by the shopper. Also, the system includes a tag detector for identifying the cart used by the shopper. Specifically, the tag detector reads a unique tag that is mounted on each cart in the store inventory. In a certain embodiment, a single detecting device, such as an RFID reader, may incorporate both the token detector and the tag detector.

For the present invention, the system also includes a scanner at the point-of-sale. Functionally, the scanner is able to read the token to recognize the shopper and to record the goods purchased by the shopper. Further, the system includes an activator for causing the token detector and the tag detector to acknowledge the return of the cart to the corral by the shopper. Also, the system employs a coupon dispenser for selectively providing the shopper with coupons. Depending on the desired embodiment, the coupon dispenser may be mounted on each cart or at each corral to print coupons for the shopper. Alternatively, the coupon dispenser may be located elsewhere and used to print coupons that are mailed to the shopper. Further, the coupon dispenser may electronically dispense coupons to the shopper via email.

In order to encourage the return of a cart to a corral by a shopper, the system includes a controller that is in wireless communication with the other system components. Functionally, the controller determines suggested goods for subsequent purchase by the shopper based on the goods recorded by the scanner and on the shopper's purchase history. Also, the controller instructs the coupon dispenser to provide coupons for the suggested goods in response to acknowledgement of the return of the cart to the corral by the shopper. In certain embodiments, the coupon dispenser provides coupons to the shopper on a subsequent shopping visit to the store.

For operation of the system, transceivers may be provided at predetermined positions throughout the store and parking lot complex. These transceivers form a communication path between the controller and the other system components. Further, the transceivers may monitor the path of the shopping cart as it moves through the store. In certain embodiments, the controller may consider the path when determining the suggested goods for subsequent purchase by the shopper. In order to monitor the path of the shopping cart, the transceivers include tag detectors, such as RFID receivers that monitor RFID tags mounted on the carts.

In the present invention, coupons are provided to a shopper to encourage the shopper to return his/her cart to a cart corral. Specifically, the coupons may be mailed or emailed to the shopper after a shopping visit in which the shopper returned his cart to a cart corral. Alternatively, the coupons may be dispensed to the shopper from the cart corral or cart at the time the cart is returned to a cart corral. Also, the coupons may be dispensed to the shopper from a cart corral or cart during the shopper's subsequent visit to the store.

Regardless of the embodiment of the system, during operation of the system, a shopper first removes a shopping cart from a shopping corral. At this time, the detectors read the shopper's token and the cart's tag. Accordingly, the identity of the cart and shopper are communicated to the controller. Thereafter, the transceivers monitor the path of the shopping cart through the store. When the shopper arrives at the point-of-sale, the scanner is used to record the goods that are to be, or have been, purchased. Further, the scanner also may be used to read the shopper's token and/or the cart's tag. During checkout at the point-of-sale, the record of the purchased goods and the identity of the shopper and/or cart are communicated to the controller. In response to the purchased goods, the shopper's purchase history, and, in some cases, to the path of the shopping cart, the controller determines suggested goods for subsequent purchase by the shopper. These suggested goods may be similar offerings from the suppliers and manufacturers favored by the shopper, goods previously purchased by the shopper, promotional goods, or the like.

If, after departing the store, the shopper returns the cart to a corral, the detectors acknowledge and communicate to the controller that the cart was returned. In response to this acknowledgement, the controller approves the shopper for receipt of coupons for the suggested goods. In the embodiment employing mailed coupons, the coupon dispenser prepares and sends coupons for the suggested goods to the shopper via mail or email.

For a system dispensing coupons to the shopper at the time of the return of the cart, the controller again approves the shopper for receipt of coupons in response to the return of the cart. Thereafter, the coupon dispenser, mounted on the cart or cart corral, provides the shopper with the coupons based on an instruction from the controller.

Alternatively, for a system dispensing coupons to the shopper during a subsequent shopping visit, the controller still approves the shopper for receipt of coupons for the suggested goods in response to the return of the cart. Further, the system may send a mail or email notification to advise the shopper of forthcoming coupons during the shopper's next visit to the store. When the shopper returns to the store during a subsequent shopping visit and retrieves a cart from the corral, the detectors communicate the identity of the shopper and the cart to the controller. In response, the controller instructs the coupon dispenser on the cart corral or cart to provide the shopper with coupons for the suggested goods.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of an embodiment of a system for encouraging the return of shopping carts to a corral in accordance with the present invention; and

FIG. 2 is a schematic view of the system in FIG. 1.

### DESCRIPTION OF THE PREFERRED EMBODIMENTS

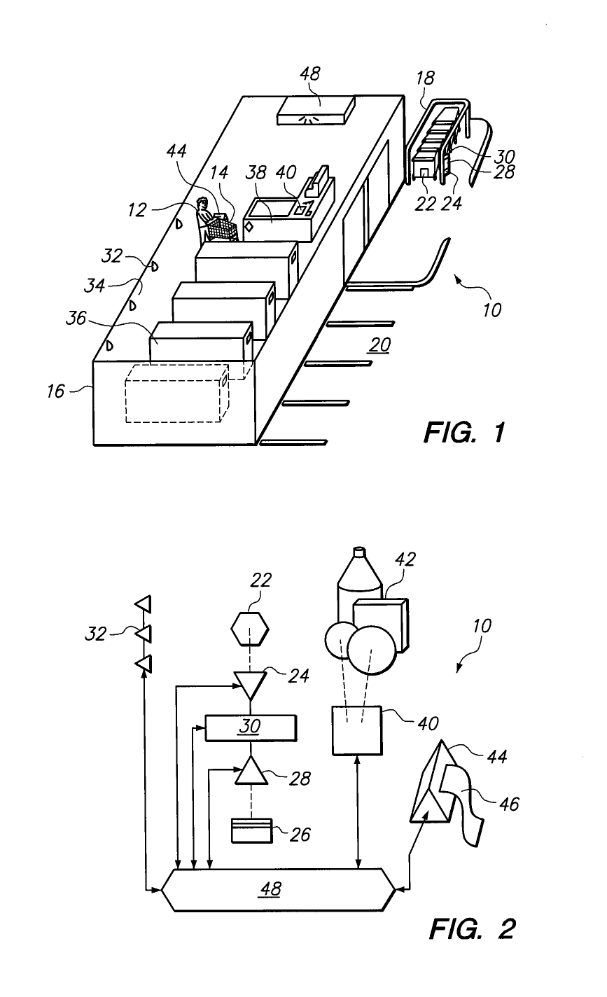

Referring initially to FIG. 1, a shopping cart accountability system is shown, and is generally designated 10. More specifically, the system 10 is used to encourage a shopper 12 to return a cart 14 after a shopping visit to a store 16. To do so, the system 10 dispenses coupons to the shopper 12 if the shopper 12 returns his cart 14 to a cart corral 18. As shown, the store 16 includes a cart corral 18 at a parking lot 20 for receiving carts 14. In the system 10, each cart 14 is equipped with a tag 22. Further, each cart corral 18 employs a tag detector 24 that is able to read the tag 22 in order to uniquely identify each cart 14. Preferably, the tag 22 is an RFID tag or similar device which the tag detector 24 is able to read from a distance. Further, the shopper 12 carries a token 26 (shown in FIG. 2) such as a frequent shopper card. In order to recognize the shopper 12, the cart corral 18 also includes a token detector 28. Typically, the token 26 includes a machine readable data strip that the token detector 28 reads when the token 26 is swiped through the token detector 28. In this manner, the system 10 is able to recognize the shopper 12.

In order to provide for an automatic response to the presence of a shopper 12, the cart corral 18 may further include an activator 30 for causing the tag detector 24 and the token detector 28 to read the tag 22 and token 26, respectively. Although shown at a single location, the system 10 preferably employs a plurality of corrals 18, with corrals 18 located throughout the parking lot 20. Further, the system 10 could include specialized return corrals 18 that are in electronic communication with a central corral 18.

For the present invention, the system 10 further includes transceivers 32 that are mounted at predetermined areas within the store 16, such as on walls 34, on aisles 36, or at the point-of-sale 38. As is commonly provided at the point-of-sale 38, the system 10 also includes a scanner 40 for recording the goods 42 (shown in FIG. 2) purchased by the shopper 12. Also, the system 10 provides a coupon dispenser 44 for dispensing coupons 46 (shown in FIG. 2) to the shopper 12. Although shown mounted to the cart 14 in FIG. 1, the coupon dispenser 44 may be mounted on the corral 18 or at other locations in the store 16. Further, the system 10 includes a controller 48. As shown in FIG. 2, the controller 48 is in electronic communication with the tag detector 24, token detector 28, activator 30, transceivers 32, scanner 40 and coupon dispenser 44. Preferably, such communication is wireless, as shown in FIG. 2.

In operation of the system 10, a shopper 12 retrieves a cart 14 from the corral 18. At this time, the tag detector 24 reads the tag 22 of the selected cart 14 and the token detector 28 reads the token 26 carried by the shopper 12. Alternatively, the shopper 12 could enter a code at the corral 18. In such a case, the code is considered to be a token 26. In any event, the detectors 24, 28 identify the selected cart 14 and recognize the shopper 12. Immediately, the identities of the cart 14 and shopper 12 are communicated to the controller 48.

As the shopper 12 directs the cart 14 through the store 16, the transceivers 32 monitor the path of the cart 14. Accordingly, the path of the cart 14 is communicated to the controller 48. When the shopper 12 proceeds to check out at the point-of-sale 38, the goods 42 are scanned by the scanner 40. Again, the identity of the goods 42 is communicated to the controller 48. In response to the purchased goods 42 and/or the path traveled by the cart 14, the controller 48 determines suggested goods for future purchase by the shopper 12.

After the shopper 12 has unloaded the cart 14, the shopper 12 returns the cart 14 to a corral 18. At this time, the activator 30 senses the return of the cart 14 and causes the detectors 24, 28 to identify the cart 14 and shopper 12. Then, the detectors 24, 28 communicate to the controller 48 that the shopper 12 successfully returned the cart 14 to the corral 18. In response, the controller 48 creates coupons 46 for the suggested goods. Importantly, the controller 48 may be programmed to promote certain store brands of goods 42, certain goods 42 that are competitive with the purchased goods, or other goods (collectively designated 42) as desired by store management.

Depending on the system 10 employed, the coupons 46 may be mailed or emailed to the shopper 12, immediately dispensed to the shopper 12 after the return of the cart 14 from a coupon dispenser 44 mounted on the cart 14 or corral 18, or dispensed to the shopper 12 from a coupon dispenser 44 during the shopper's next visit to the store 16. For the last embodiment, the shopper 12 may be notified by mail or email that coupons 46 of the pending coupons 46. Further, when the shopper 12 returns to the store 16, the detectors 24, 28 will recognize the shopper 12 and identify the cart 14 selected. The controller 48 will then instruct the coupon dispenser 44 to provide the shopper 12 with coupons 46 for the selected goods. In this manner, the shopper 12 is rewarded for returning the cart 14 on his previous shopping visit.

While the particular System and Method for Shopping Cart Accountability Using Coupon Incentives as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A method for encouraging a shopper to return a shopping cart to a corral at a store comprising the steps of:
recognizing the shopper;
identifying the cart used by the shopper;
acknowledging the return of the cart to the corral by the shopper; and
providing the shopper with coupons in response to the acknowledging step for use when the shopper returns to the store.

2. A method as recited in claim 1 further comprising the steps of:
recording the goods purchased by the shopper; and
determining suggested goods for subsequent purchase by the shopper, wherein the coupons are provided for purchase of the suggested goods.

3. A method as recited in claim 2 wherein the suggested goods are determined based on the goods purchased by the shopper.

4. A method as recited in claim 2 further comprising the step of monitoring a path traveled by the customer through the store, and wherein the suggested goods are determined based on the goods purchased by the shopper and on the path traveled by the customer.

5. A method as recited in claim 1 wherein the recognizing step is accomplished by electronically reading a token assigned to the shopper.

6. A method as recited in claim 5 wherein the identifying step is accomplished by detecting a tag mounted on the cart.

7. A method as recited in claim 6 wherein the acknowledging step is accomplished by activating a receiver.

8. A method as recited in claim 7 wherein the receiver acknowledges the cart and the shopper.

9. A method as recited in claim 1 wherein the providing step is accomplished during a subsequent shopping visit by the shopper at the store.

10. A method as recited in claim 9 wherein a coupon dispenser is mounted on the cart to provide the coupons to the shopper in response to the acknowledging step.

11. A system for encouraging a shopper to return a shopping cart to a corral at a store comprising:
means for recognizing the shopper;
means for identifying the cart used by the shopper;
means for acknowledging the return of the cart to the corral by the shopper; and
means for providing the shopper with coupons in response to the return of the cart for use when the shopper returns to the store.

12. A system as recited in claim 11 further comprising:
means for recording the goods purchased by the shopper; and
means for determining suggested goods for subsequent purchase by the shopper, wherein the coupons are provided for purchase of the suggested goods.

13. A system as recited in claim 12 further comprising a means for monitoring a path traveled by the customer through the store, and wherein the means for determining the suggested goods considers the goods purchased by the shopper and the path traveled by the customer.

14. A system as recited in claim 12 wherein the recording means includes a scanner at a point-of-sale.

15. A system as recited in claim 11 wherein the recognizing means includes a token assigned to the shopper and a token receiver for reading the token.

16. A system as recited in claim 15 wherein the identifying means includes a tag mounted on the cart and a tag receiver for reading the tag.

17. A system as recited in claim 16 wherein the acknowledging means includes an activator for activating the token receiver and the tag receiver.

18. A system as recited in claim 11 wherein the providing means is a coupon dispenser mounted on the cart.

19. A system for encouraging a shopper to return a shopping cart to a corral at a store comprising:
a token detector for reading a token carried by the shopper to recognize the shopper;
a tag detector for reading a tag mounted on the cart used by the shopper to identify the cart;
a scanner at the point-of-sale for reading the token to recognize the shopper and for recording the goods purchased by the shopper;
a controller in communication with the scanner for determining suggested goods for subsequent purchase by the shopper;
an activator for causing the token detector and the tag detector to acknowledge the return of the cart to the corral by the shopper; and
a coupon dispenser for selectively providing the shopper with coupons for purchase of the suggested goods when the shopper returns to the store.

20. A system as recited in claim 19 wherein the controller is in communication with the token detector, tag detector, scanner, and coupon dispenser to instruct the coupon dispenser to provide the shopper with coupons for purchase of the suggested goods during a subsequent shopping visit to the store in response to acknowledgement of the return of the cart to the corral by the shopper on a previous shopping visit to the store.
